(19) United States
(12) Patent Application Publication
(10) Pub. No.: US 2016/0098947 A1
(43) Pub. Date: Apr. 7, 2016

(54) Ninja Sign

(71) Applicants: Russell Richard Smith, Bolivar, MO (US); Kenneth Dale Coleman, Branson, MO (US)

(72) Inventors: Russell Richard Smith, Bolivar, MO (US); Kenneth Dale Coleman, Branson, MO (US)

(21) Appl. No.: 14/872,064

(22) Filed: Sep. 30, 2015

Related U.S. Application Data
(60) Provisional application No. 62/058,285, filed on Oct. 1, 2014.

(51) Int. Cl. G09F 15/00; G09F 7/00; G09F 17/00; G09F 7/18

(52) U.S. Cl. CPC G09F 15/0068; G09F 7/18; G09F 7/002; G09F 17/00; G09F 2007/1804; G09F 2007/1843

(57) ABSTRACT

The disclosed invention generally pertains to a collapsible sign having an open arm span that is substantially larger than that of the closed arm span, thus allowing the open frame to hold a much larger sign face than the closed frame. The face of the sign can be made to collapse as well thus further reducing the over-all size of the stored sign. Among other uses, the Ninja Sign is great for residential and commercial real estate agents, and it is not limited to outdoor applications.

### CROSS-REFERENCES TO RELATED APPLICATIONS

This application claims the benefit of U.S. provisional patent application No. 62/058,285 that was filed on Oct. 1, 2014. The disclosure of this provisional application is expressly incorporated by reference herein.

### FIELD OF THE INVENTION

The disclosed invention generally pertains to a collapsible sign. More specifically, the invention pertains to a Ninja Sign having an open arm span that is substantially larger than that of the closed arm span, thus allowing the open frame to hold a much larger sign face than the closed frame; it also allows the sign frame to be stored and transported more easily. The face of the sign can be made to collapse as well thus further reducing the over-all size of the stored sign. Among other uses, the Ninja Sign is great for residential and commercial real estate agents, and it is not limited to outdoor applications.

### BACKGROUND OF THE INVENTION

In many instances companies or individuals like to take advantage of yard space to advertise various campaigns, sales, or business related events; often times this is done via transportable signs. Yard signs come in all shapes, and designs, but what is important for most signs are the aesthetics, elevation height of the face, and ease of use. Signs that are too low can become hidden by grass, or small bushes that render the sign less useful, while a lack of aesthetics can often times indicate a lack of professionalism of the company or individual that it is advertising. Most yard signs are bulky and hard to fit in the average size vehicle; they can be inconvenient to reuse because they are not compact enough to store efficiently for the next use. Thus, many larger signs simply have a one-time use.

It is quite common for business personnel, such as real estate agents, to have to set up multiple yard signs on a daily basis. To do so, the signs must first be transported to the selected site, which typically requires that the agent try and fit several large signs in their vehicle without causing scratches or dents. Simply placing multiple signs in a vehicle can allow for the signs to rattle against each other making it very difficult to communicate with clients that are in the vehicle with you, and causing damage to the signs. Not to mention that the size of the sign is often times very limited by the size of the vehicle carrying it.

Once at the desired location, the sign must either be set on the ground and left, which means that the sign must be heavy enough to not blow away, or it must have stake(s) that go into the ground. The heavier sign obviously makes it less user friendly, while putting stake(s) in the ground can be rough on the sign frame; this is because often times the stake(s) are part of the sign frame itself with no direct hitting point except for the top of the sign frame. Thus putting the stake(s) in hard ground can require that you hammer on the frame, which causes unwanted damage. Not to mention that many signs require additional tools that take up space, and inconvenience the user.

Many yard signs are large which can require the user to maintain a storage shed. Often times, in the real estate industry, yard signs are simply left outdoors leaning against the company building simply because the signs are not compact enough to store inside without a shed.

It is desirable to provide an easy to use sign that can be more conveniently stored, in the form of a Ninja Sign. Although Ninja Signs come in multiple sizes, the design can allow for the user to transport over 10 commercial size signs in the average size trunk. Ninja Signs can be aesthetically pleasing, and easy to see due to their elevated face height. They are designed to be hammered into hard ground using the frame as a post driver. The frame is also designed to make it easy to remove the stake from the ground by using the frame as a reverse post driver. Thus, no additional tools are required. Although, the Ninja Sign is great for outdoor use, it is not limited to outdoor applications.

### BRIEF SUMMARY OF THE INVENTION

The disclosed invention pertains to a transportable sign that is compact for storage, and easy to use. There are many variations of the design and this brief summary of the invention is not intended to limit the scope of the invention in any way, as it is merely exemplary.

A Ninja Sign comprising a rigid, spanning member approximately the length of a sign face in height (length referring to vertical length of the face). At one end of the spanning member is a housing assembly, and at the other end there is a mounting device for mounting the spanning member to a hard floor in a vertical position (both the housing assembly and the mounting device are described below, along with other components of the Ninja Sign). A spanning member can be hollow, thus being able to accommodate a stake that can be extended out the mounting device end of the spanning member. Two flanges, one on the inside of the spanning member near the mounting device, and the other on the stake near the top, can prevent the stake from being completely removed from the spanning member. Thus, the stake can be partially extended out the spanning member and pinned such that the extended portion of the stake is the desired length for inserting into the ground. The pin prevents the stake from going all the way back inside the spanning member.

The Ninja Sign would ideally have two arms, each comprising a first arm component, and a second arm component (an arm can be just a first arm component). The second arm components can be approx. the length of the spanning member, and in a closed position they can appear on opposite sides of the spanning member while extending from the mounting device to the housing assembly. A first arm component connects a second arm component to the housing assembly; it can do so such that each second arm component can rotate relative to its respective first arm component, and each first arm component can rotate about a point on/in the housing assembly. The pivot point between a first arm component and a second arm component will partly determine the sign face height and size as explained below: for conceptual purposes it is safe to make this point slightly lower than the center of a second arm component. The second arm components can be connected at their respective ends to the housing assembly and mounting device to secure them in a closed position.

The housing assembly holds the arms to the spanning member such that the arms and spanning member can lie within a small variation of a common plane in the open, and/or closed position(s). The housing assembly can be part of the spanning member, or it can be a separate component. The arms, housing assembly, and mounting device should each be symmetrical about a line parallel to, and through the center of the spanning member in a closed and open position. They should also be minimal in size, and compact to reduce storage space.

A mechanical system can connect the first arm components of the arms such that when one first arm component rotates relative to the spanning member, the other one rotates an equal amount in the opposite direction. Thus the two first arm components maintain a common angle relative to the spanning member. This mechanical system can consist of a set of congruent, interlocking gears in/on the housing assembly; each gear attached to a first arm component and centered at the point of rotation of each respectively. Thus when one first arm component rotates, the interlocking gears cause the other first arm component to rotate an equal amount in the opposite direction.

The mounting device can be used to mount the spanning member to a hard surface in a vertical position. In many outdoor applications, where the Ninja Sign cannot be mounted to a hard surface, the stake can be extended from the spanning member and pinned. The frame (comprising the spanning member, and arms) can then be used as a manual post driver for inserting the stake into the ground.

After the spanning member is firmly mounted vertically, the ends of the second arm components can be disconnected from the housing assembly and mounting device thus allowing the arms to rotate about their respective points in the housing assembly. The first arm components can be rotated to a horizontal position and temporarily secured in place from below (allowing them to rotate up but not down), while the two second arm components are able to move independent of each other until the face(s) are attached. Rectangular sign face(s) can then be mounted on the frame by attaching each top corner of each face to one end of a different second arm component (housing assembly end). One bottom corner (common side) of each face can then be attached to the mounting device end of its respective second arm component, thus we have 3 of the 4 corners of each face mounted on the arms. The 4th corner of each face can be attached to the remaining end of the second arm component by rotating each second arm component to as vertical of a position as the face will allow. Holding the remaining end of the second arm component and pushing it towards the spanning member will cause the first arm components to rotate, while bringing the mounting device ends of the second arm components closer together, and thus allowing you to attach the 4th corner of the face(s) to the frame. After connecting the 4th corner of a face, and letting go, the weight of the arms pull the face(s) taunt.

To remove the Ninja Sign, press one end (mounting device end) of a second arm component towards the housing assembly and disconnect the face(s) at that end. Lower the arms by allowing respective end of the second arm component to slowly move away from the spanning member which will cause the arms to lower. Disconnect the face(s) from the frame and secure the respective ends of the second arm components to the housing assembly and mounting device. Disconnect the mounting device from the floor if applicable. If applicable, use the frame as a reverse post driver to hammer the stake out of the ground. Then remove the stake pin and slide the stake back inside the spanning member. Thus the ( ) is in the closed position.

Some of the many advantages of the invention over prior art can include, but are not limited to: not needing any tools to set up the Ninja Sign, reducing storage space, making it easier to reuse and transport signs, improved elevation height of the face(s), and the ability to put a sign up that is taller than you physically are.

### BRIEF DESCRIPTION OF THE DRAWINGS

FIG. 1 is an isometric view of a Ninja Sign in a closed, and horizontal position.

FIG. 2 shows that which is depicted in FIG. 1 but with a stake extended from a spanning member.

FIG. 3 shows that which is depicted in FIG. 2 but with a stake pin inserted into a stake.

FIG. 4 is a front view of a Ninja Sign in hammering position A: a vertical frame where the arms are in a closed position, a stake is extended out the spanning member and pinned, and the mounting device is resting on the stake pin. The mark near the bottom of the stake represents ground surface level.

FIG. 5 is a front view of a Ninja Sign in hammering position B: a vertical frame where the arms are in a closed position, a stake is maximally extended out the spanning member, and a pin is in the stake. The mark near the bottom of the stake represents ground surface level.

FIG. 6 shows that which is depicted in FIG. 4 but with the bottom of a stake below ground surface level.

FIG. 7 shows that which is depicted in FIG. 5 but with the bottom of a stake below ground surface level.

FIG. 8 illustrates that which is shown in FIG. 6 but with the bottom of a stake inserted further past ground surface level.

FIG. 9 shows that which is depicted in 7 but with the bottom of a stake inserted further past ground surface level.

FIG. 10 is a front view illustrating a Ninja Sign with the arms closed, and the entire bottom portion of a stake properly inserted below ground surface level.

FIG. 11 is an isometric view of a Ninja Sign in a vertical position, with the arms in a closed position.

FIG. 12 is an isometric view of the back of a Ninja Sign in a vertical position, with the arms partially open.

FIG. 13 is an isometric view of the back of a Ninja Sign in a vertical position, with the arms partially open.

FIG. 14 shows that which is depicted in FIG. 13 but with the second arm components rotated further into a vertical position.

FIG. 15 is a front view of a vertical Ninja Sign with the arms in position for applying at least one face.

FIG. 16 shows that which is depicted in FIG. 15 but with a face partially connected to a frame; a face being fully secured to a second arm component on the left, but only connected to the top of another second arm component on the right.

FIG. 17 is a front view of a Ninja Sign in a fully open position.

FIG. 18 is a back view of a Ninja Sign in a fully open position having only one face.

FIG. 19 is a rear isometric view of a Ninja Sign having two faces in a fully open position.

FIG. 20 is a front view of a rectangular face having one grommet per corner for attaching to the arms of a frame.

FIG. 21 is a front elevated close up view of a housing assembly.

FIG. 22 is a bottom elevated view of a mounting device, and the top of a stake.

FIG. 23 is an isometric view of Ninja Sign comprising a third arm component wherein the first, second, and third arm components form a frame for attaching to a face in an open position.

FIG. 24 Is an isometric view of a Ninja Sign comprising a third arm component wherein the arms are in a partially closed position.

FIG. 25 is an isometric view of a Ninja Sign wherein first arm components are on opposite sides of a spanning member 1 in a closed position.

FIG. 26 is an isometric view of the Ninja Sign in FIG. 25 having a first arm component rotated past horizontal into an open position.

FIG. 27 is an isometric view of the Ninja Sign in FIG. 26 having a second first arm component rotated towards the first.

FIG. 28 is a front view of a Ninja Sign in an open position, having 4 first arm components.

### DETAILED DESCRIPTION OF THE INVENTION

The following detailed description of the invention is simply exemplary and is not intended to limit the scope, application, or use of the invention. Neither the background of the invention, brief description of the drawings, nor the following detailed description of the invention are intended to be binding or limiting in any way as there are many variations of the Ninja Sign.

### DEFINITIONS

A spanning member refers to a rigid component, or system of components, that couple a housing assembly and a mounting device by a given separation distance; a spanning member being in a vertical position when a housing assembly is positioned above a mounting device.
A mounting device refers to a component, or a system of components, that comprises means of coupling a spanning member to a surface or a stake, thus securing a spanning member in a desirable position.
A housing assembly is a rigid component(s) comprising means of coupling an arm to a spanning member.
An arm comprises a rigid member used to couple a face to a housing assembly in an open position. An arm can be comprised of multiple components (Example: a first arm component, second arm components etc.)
A mechanical system shall refer to a device, or devices, that increase the stability of the arm(s) in an open position.
A stake shall refer to a rigid object that gets hammered, or inserted, into the ground.
Open position shall refer to fully erect position.
Face shall refer to a sign face; a sign face can be rigid or roll able/collapsible.
Post driver/reverse post driver shall refer to a device for driving a stake into the ground, or driving a stake out of the ground respectively.
A mounting device, a post driver/reverse post driver, and or housing assembly could each be a part of, rather than a coupled component of, a spanning member.

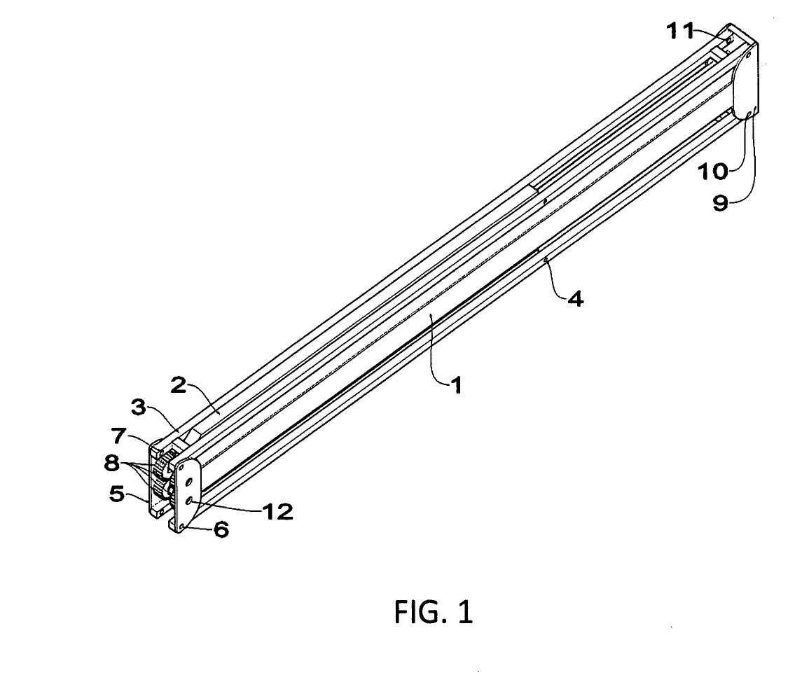

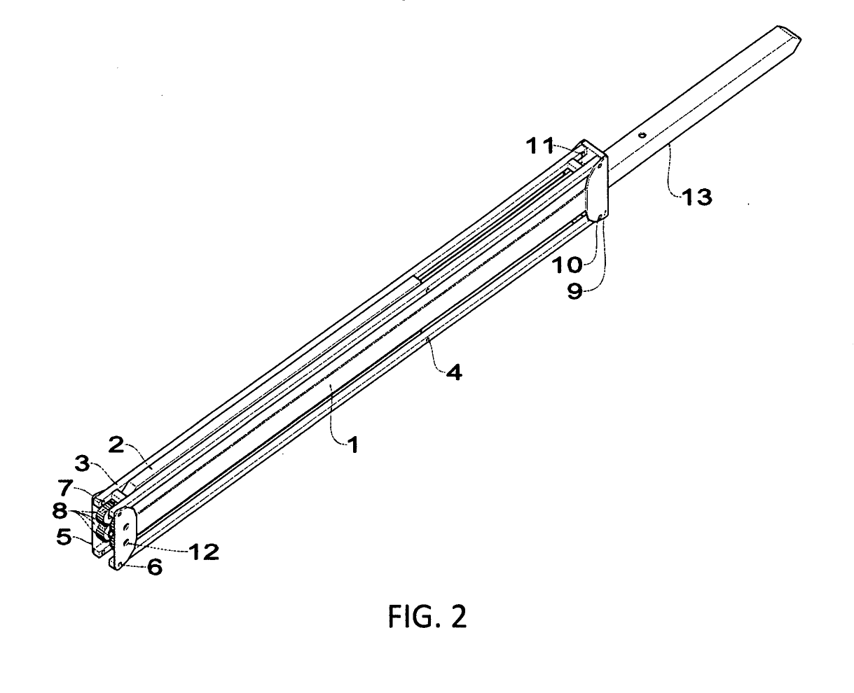

FIG. 1 is an isometric view illustrating a Ninja Sign in a horizontal and closed position comprising: a spanning member 1 coupled to a first and second arm: each arm comprised of a first arm component 2, and a second arm component 3, wherein each component lies within a region on or between a housing assembly and a mounting device, and each arm lies adjacent to a spanning member with a limited arm motion in a closed position. Two side plates 5 symmetrically attached on opposite sides of one end of a spanning member 1 help form a housing assembly. Two side plates 9 symmetrically attached on opposite sides of the other end of a spanning member 1 help form a mounting device in the form of a brace. A second arm component 3 can pivot relative to its respective first arm component 2 about a pin through hole 4. Holes 7 in a second arm component 3 align with their respective holes 6 in a side plate 5. Likewise, holes 11 in a second arm component 3 align with their respective holes 10 in a side plate 9. Holes 6, 7, 10, and 11 allow the second arm components 3 to be securely attached via pins to a housing assembly and brace. A pin through a housing assembly inserted through hole 12 penetrates a gear 8, a first arm component 2, and another gear 8, thus connecting an arm and two gears to a housing assembly. A spanning member accommodating a stake as shown in FIG. 2.

FIG. 2 depicts that which is shown in FIG. 1 with a stake 13 partially extended out the brace end of a spanning member 1.

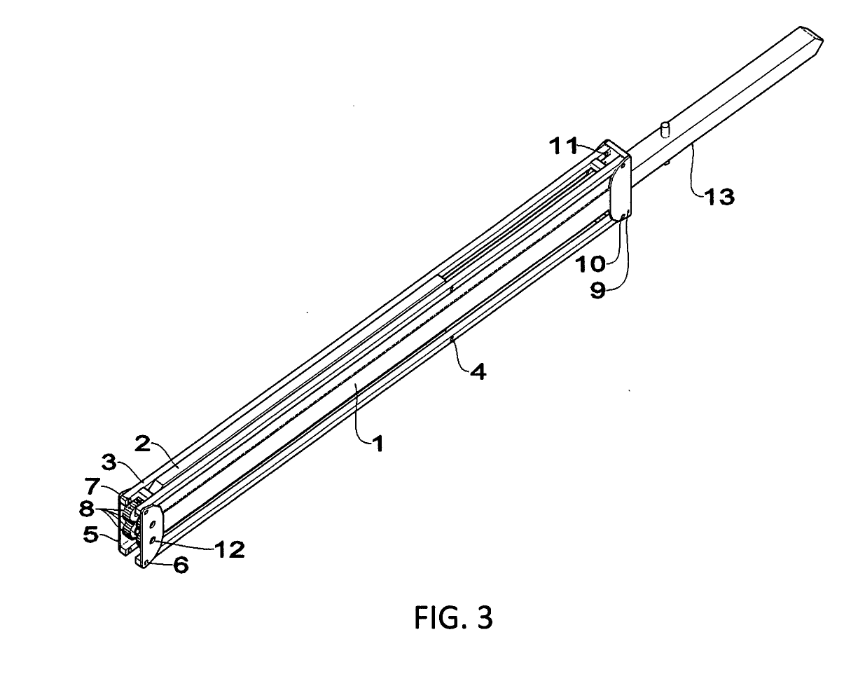

FIG. 3 shows that which is depicted in FIG. 2 but with a stake 13 pinned below a spanning member 1 to allow only part of a stake 13 to be reinserted back into a spanning member 1.

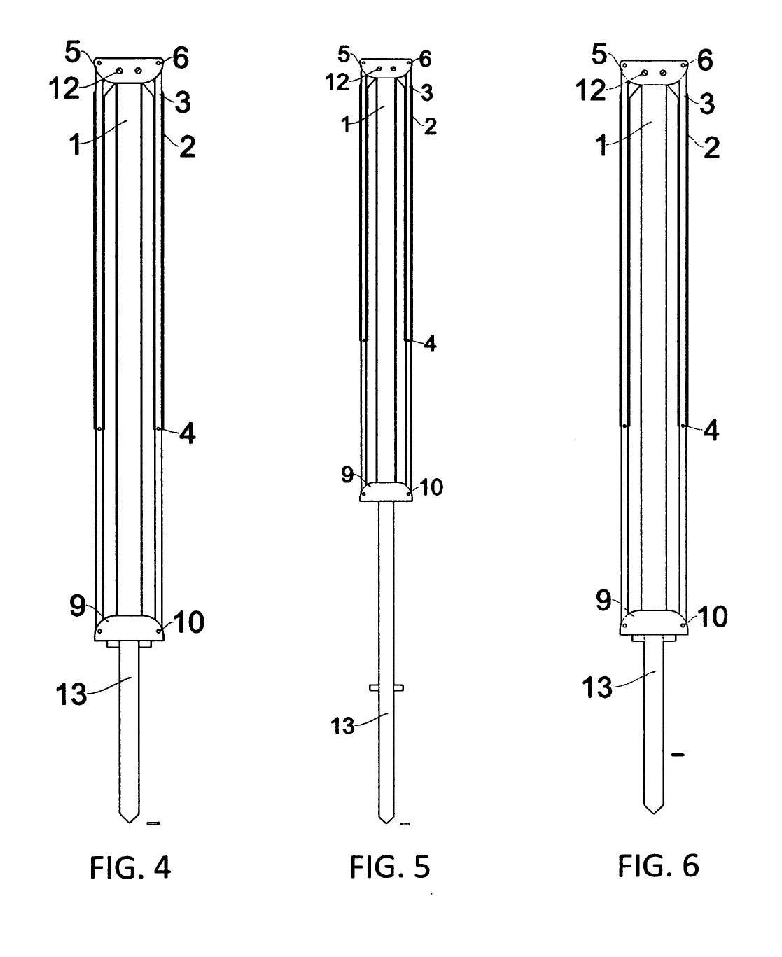

FIG. 4 is a front view illustrating that which is shown in FIG. 3 with a Ninja Sign in hammering position A having a spanning member being vertical to the ground. The arms are closed, and the bottom of a stake 13 is extended out the brace end of a spanning member 1 and pinned with the brace resting on the pin. The mark near the bottom of a stake 13 is at ground surface level.

FIG. 5 illustrates hammering position B: the same as hammering position A but with the frame elevated thus extending the stake 13 out of the spanning member 1 further.

FIG. 6 illustrates that which is depicted in FIG. 4 but with the bottom of a stake 13 partially below ground surface level.

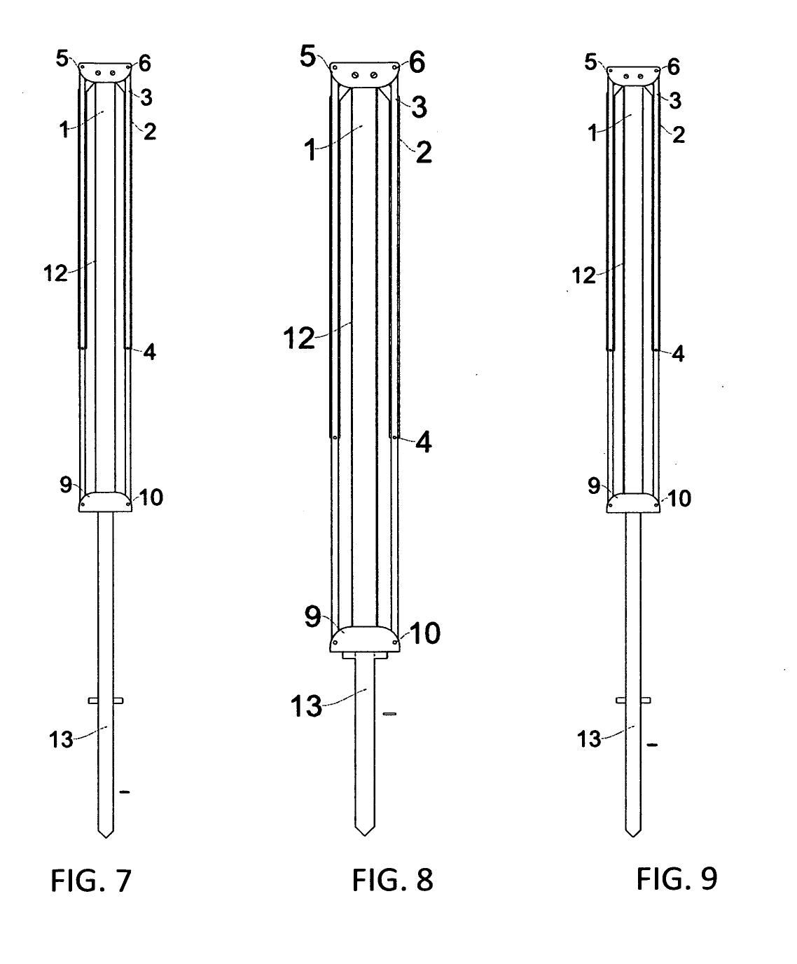

FIG. 7 illustrates that which is depicted in FIG. 5 but with the bottom of a stake 13 partially below ground surface level.

FIG. 8 illustrates that which is depicted in FIG. 6 but with the bottom of a stake 13 further below ground surface level.

FIG. 9 illustrates that which is depicted in FIG. 7 but with the bottom of a stake 13 further below ground surface level.

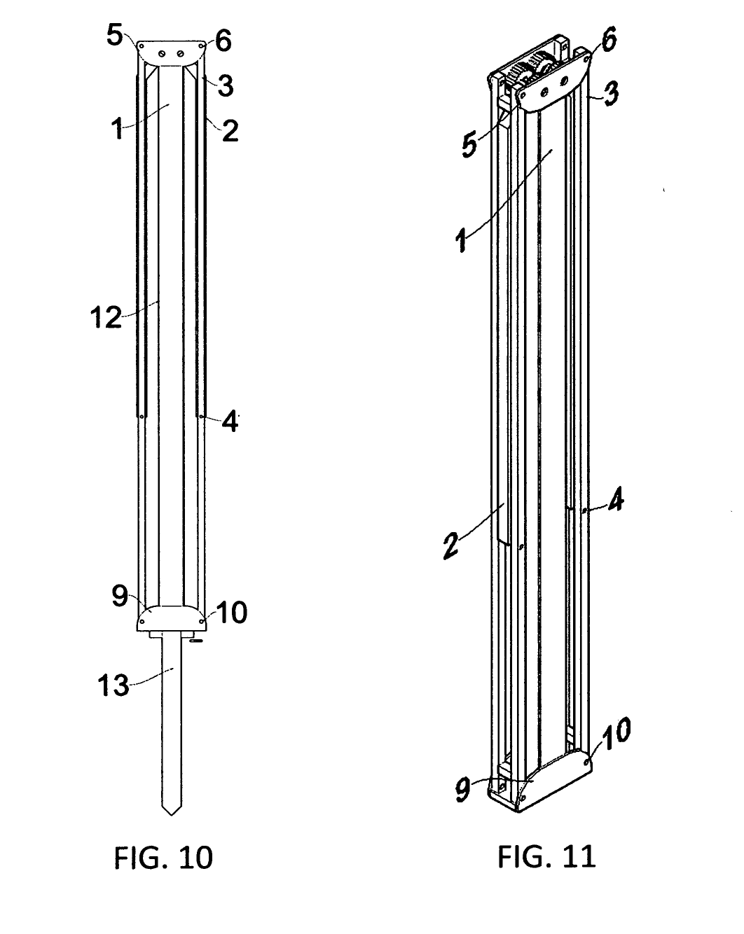

FIG. 10 illustrates that which is depicted in FIG. 8 but with a stake 13 properly inserted into the ground.

FIG. 11 is an isometric view of a Ninja Sign with first arm components 2 and second arm components 3 in a closed position. A spanning member being vertical.

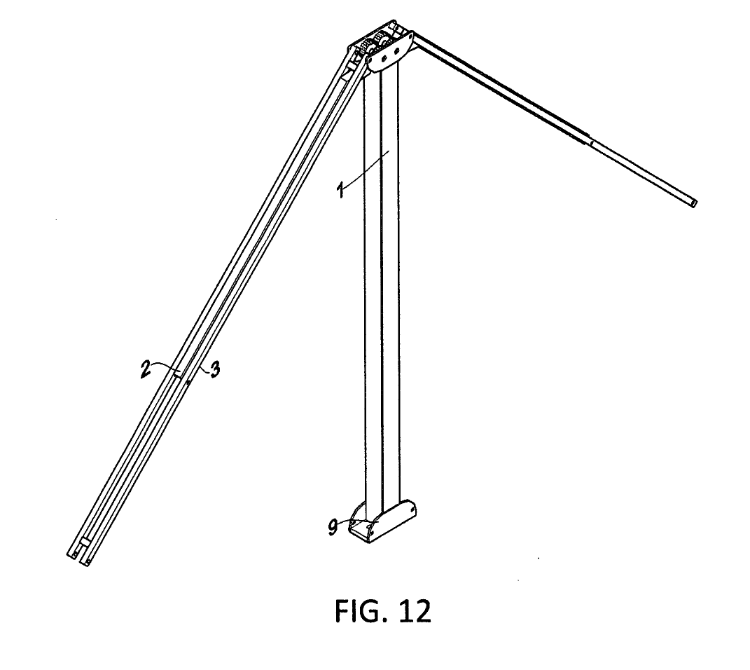

FIG. 12 is an isometric view of the back of a Ninja Sign having first arm components 2 and second arm components 3 partially open, having pivoted about the center of hole 12 respectively.

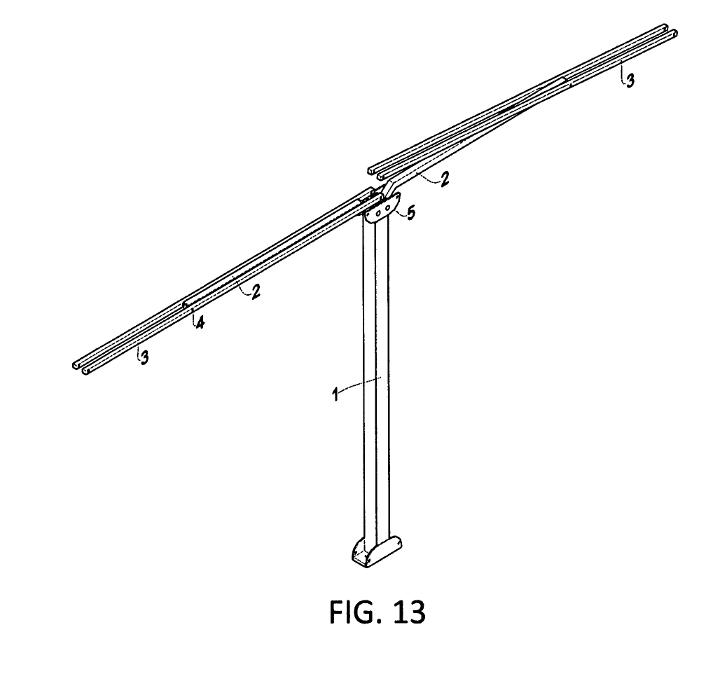

FIG. 13 is a rear isometric view of a Ninja Sign having first arm components 2 and second arm components 3 partially open, having pivoted about the center of hole 12 respectively. The first arm components 2 being horizontal.

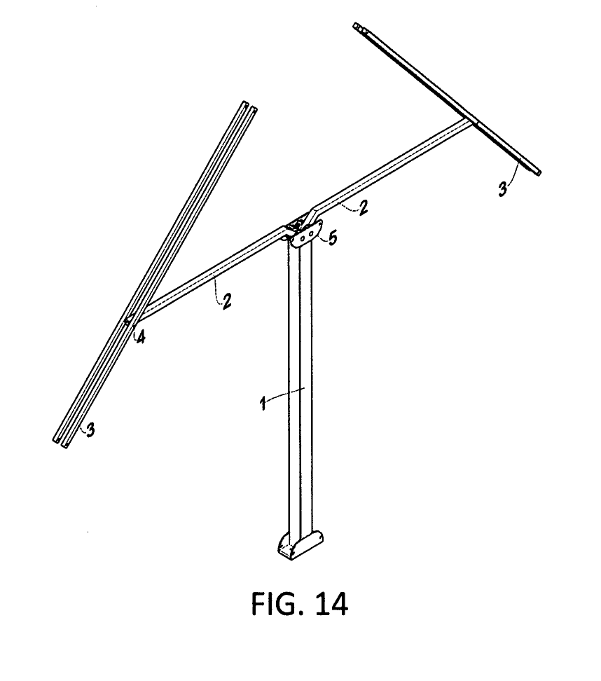

FIG. 14 shows a rear isometric view of a Ninja Sign with first arm components 2 being horizontal, and second arm components 3 being partially rotated into a vertical position. Second arm components pivotally coupled near the middle to first arm components. “Near the middle” meaning not at the ends. Arm components rotate relatively parallel to a common plane.

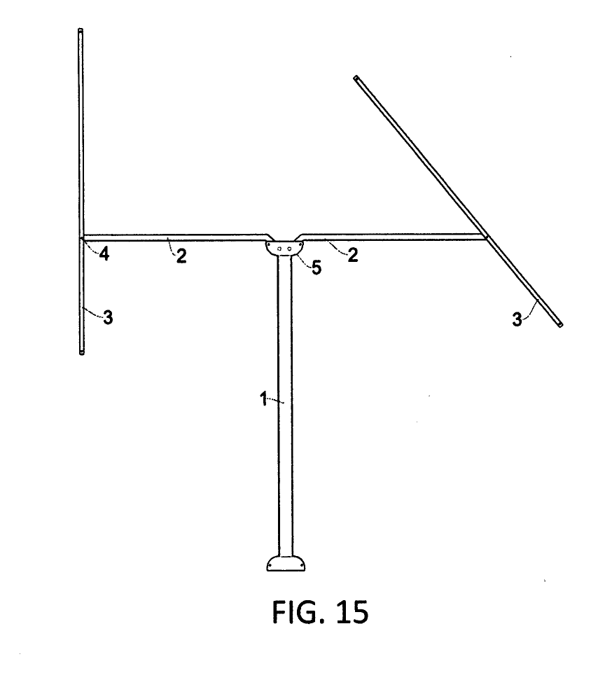

FIG. 15 shows a front view of a Ninja Sign with first arm components 2 being horizontal, with one second arm component 3 being vertical, and the other second arm component 3 being partially rotated into vertical position. First arm components pivot at a relatively common elevation on a housing assembly.

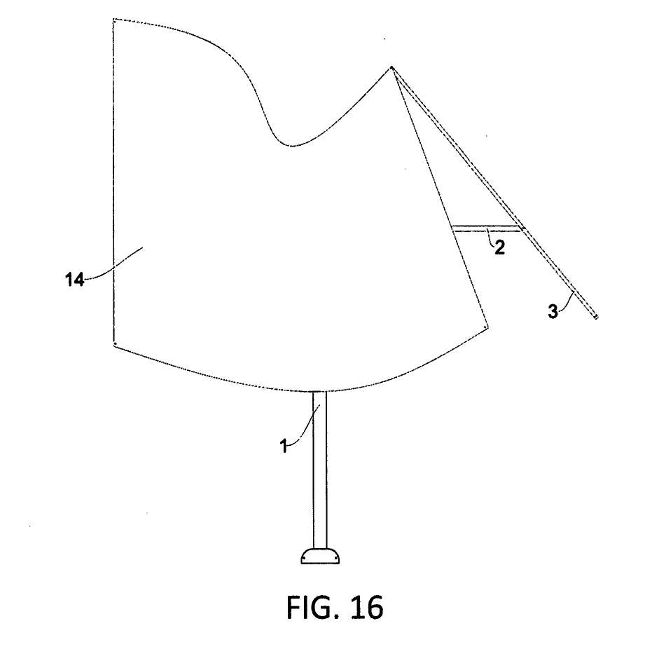

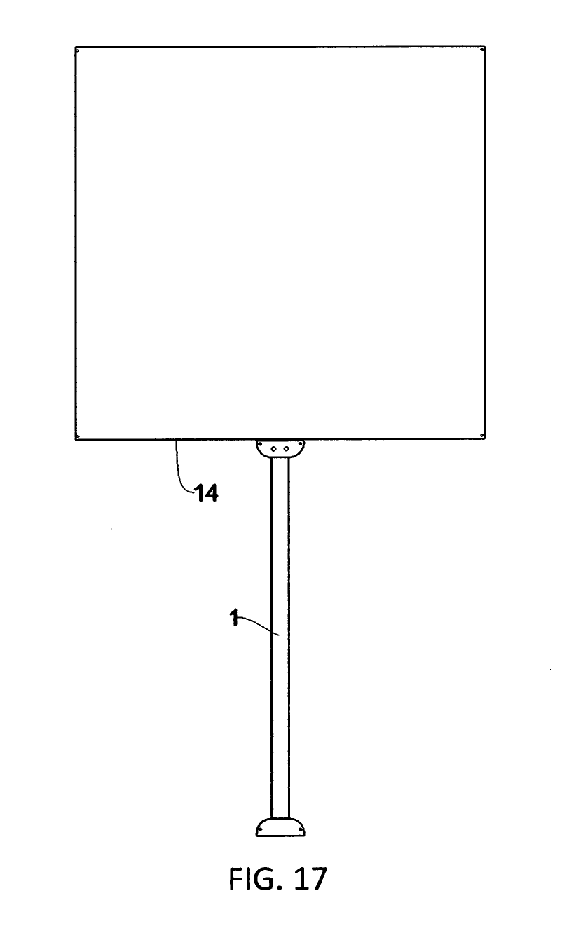

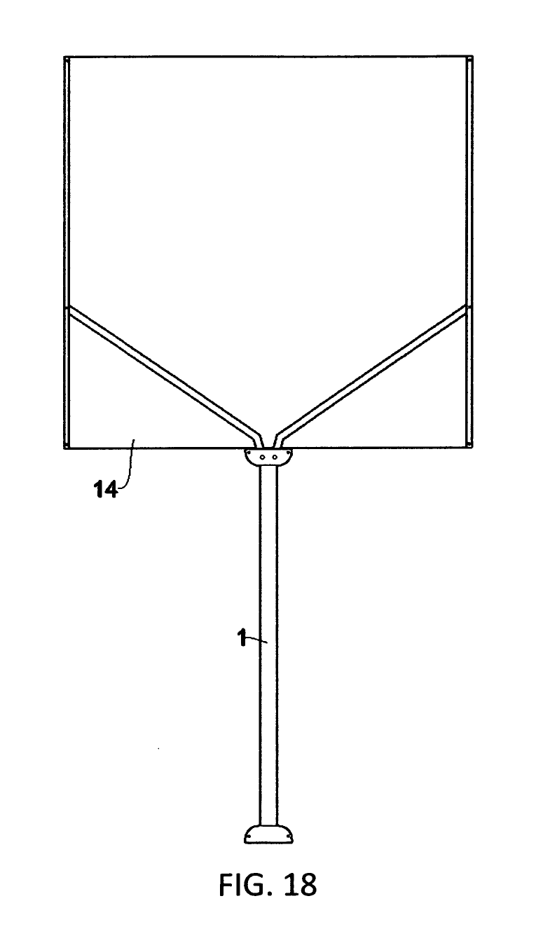

FIG. 16 shows that which is depicted in FIG. 15, but with a face partially attached to a Ninja Sign at three of the four corners. A pin through each attached corner penetrating through holes 7 and 11 respectively hold the face on a second arm component 3. While holding the unattached end of the second arm component 3, an applied force directed towards the housing assembly can move the arms into fully open position as shown in FIGS. 17 and 18. A face 14 being roll able/foldable.

FIG. 17 is a front view of a Ninja Sign in a fully open position having only one face attached.

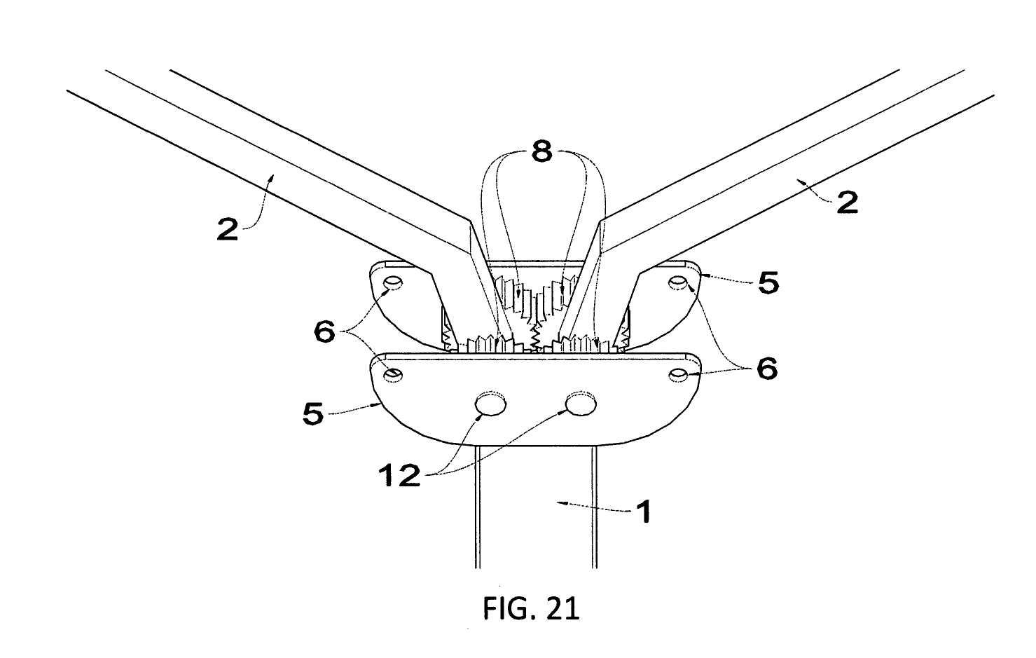

FIG. 18 is a rear view of a Ninja Sign in a fully open position having only one face attached. A wind directed towards the face causes the first arm components to rotate closer together thus reducing the cross sectional area of the face to relieve stress on the frame. See FIG. 21.

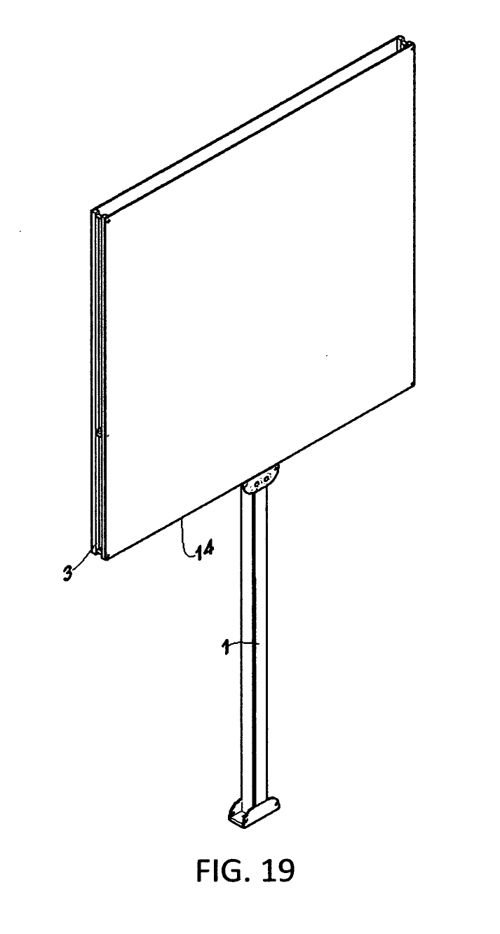

FIG. 19 is a rear isometric view of a fully open Ninja Sign having two faces, one on each side attached to the second arm components 3.

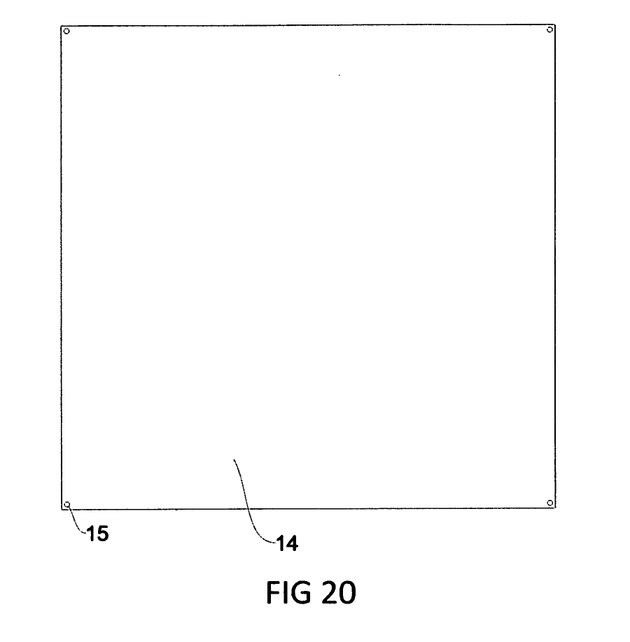

FIG. 20 is a front view of a rectangular face 14 having a grommet 15 in each corner for attaching to a second arm component via a pin.

FIG. 21 is a front elevated view of a housing assembly with two first arm components 2, and a mechanical system. First arm components 2 each insert into the housing assembly between two side plates 5, and two gears 8. Pins through holes 12 respectively penetrate both side plates 5, both gears respectively, and a first arm component 2, thus, securing the first arm components 2, and gears 8 to the housing assembly. Gears 8 centered at the same hole 12 are additionally connected to their respective first arm components 2, thus, when one first arm component 2 rotates relative to the spanning member 1, the interlocking gears 8 force the other first arm component 2 to rotate the same amount in the opposite direction. Gears 8 in a housing assembly assure that first arm components 2 stay symmetrical about a vertical line through a housing assembly, thus holding the face(s) 14 symmetrical as well.

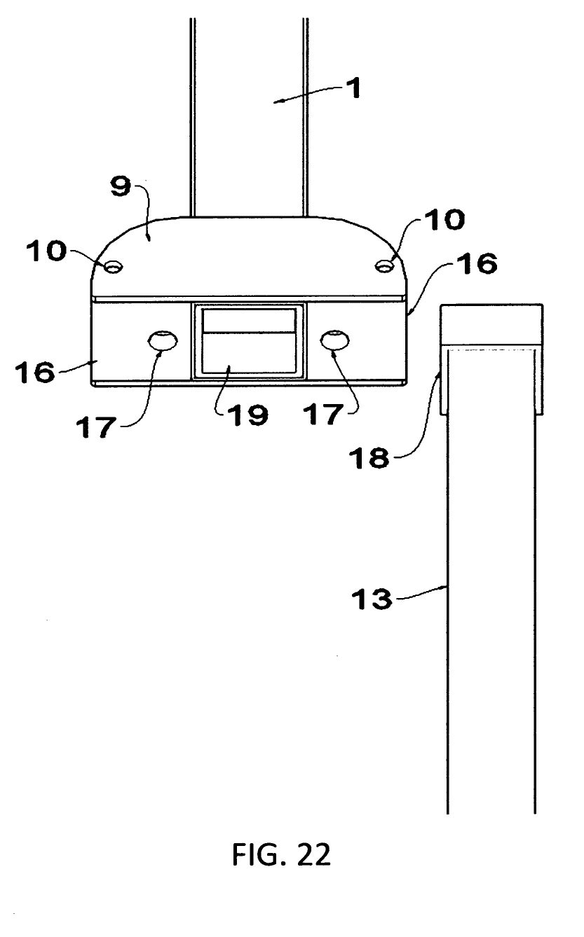

FIG. 22 is a bottom elevated view showing a brace, and a top portion of a stake 13. A brace comprising two side plates 9, and two spacers 16 each having a hole 17 for mounting the Ninja Sign to a solid surface. Flange 19 in a spanning member 1, and flange 18 on the top portion of a stake 13, prevent a stake 13 from being completely removed out the brace end of a spanning member 1 after being inserted in the housing assembly end.

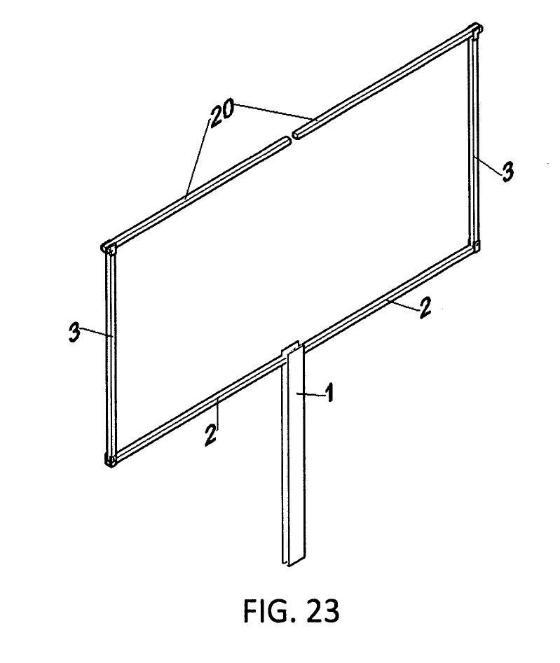

FIG. 23 is an isometric view of a Ninja Sign comprising third arm components 20 such that second arm components 3 pivot at the ends of first arm components 2, and third arm components 20 pivot at the ends of second arm components 3; third arm components 20 couple at the top in an open position forming a face frame for holding a face 14.

FIG. 24 is an isometric view of the Ninja Sign from FIG. 23 wherein the arms are in a partially closed position. The third arm components 20 being adjacent to their respective second arm components 3. Arm components 20, and 3 then fold inwards until resting on first arm components 2 respectively. Each arm then rotates downwards until all arm components 2, 3, 20 are parallel to spanning member 1.

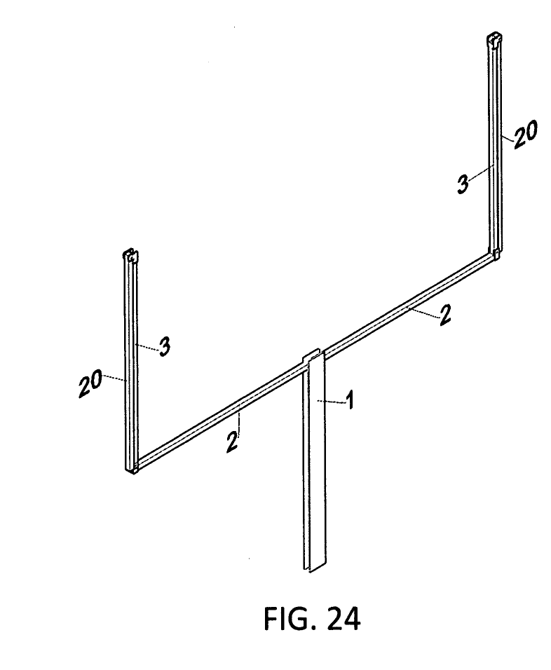

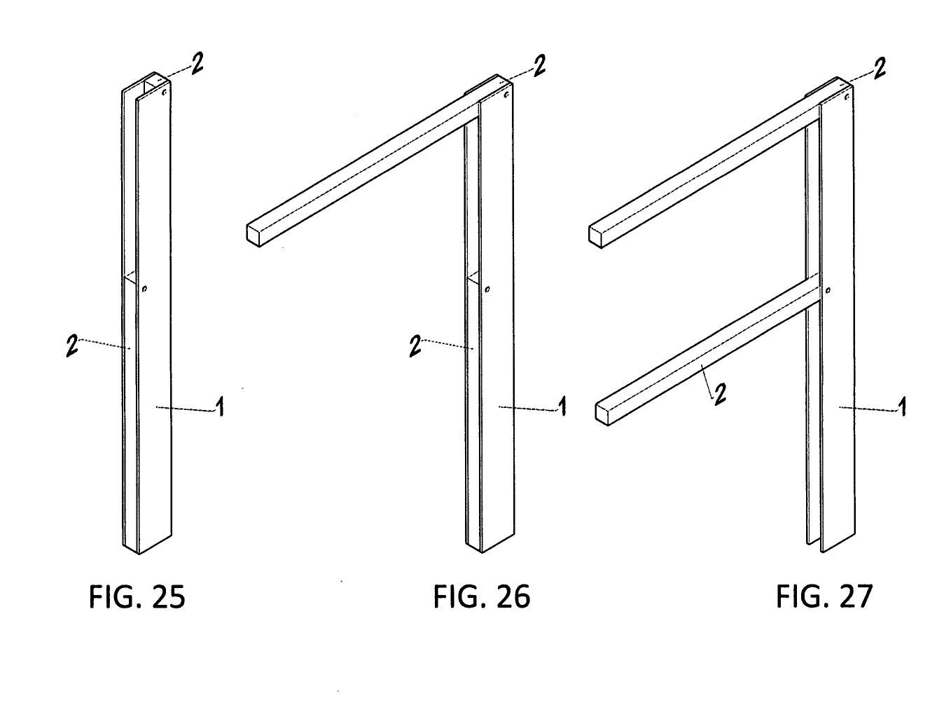

FIG. 25-27 are isometric views of a Ninja Sign comprising: a first arm component 2 that rotates past horizontal, over the top of a spanning member 1 into an open position as shown in FIG. 26, and is held up by restricting the motion of a respective joint thus giving the joint limited rotation; and a second first arm component 2 that rotates in an opposite direction, as shown in FIG. 27.

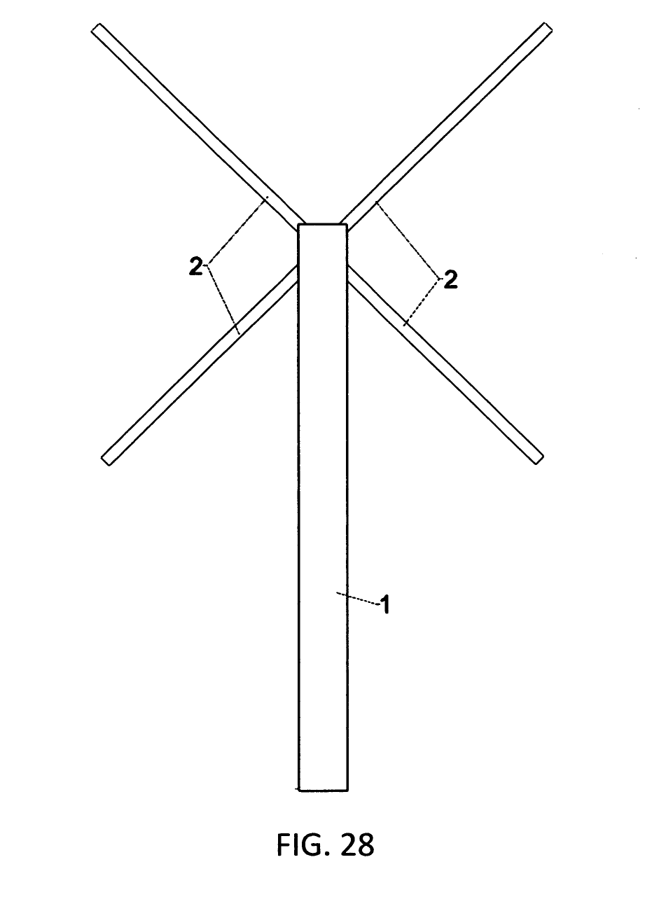

FIG. 28 is a front view of a Ninja Sign comprising a spanning member 1 having 4 first arm components 2 attached for holding a face 14.

### Means of Manufacturing:

A spanning member 1 can be constructed out of steel square tubing cut to the proper length. A housing assembly can be constructed by utilizing a set of small side plates 5; each side plate having four holes 6 and 12 can be cut out with a laser and positioned at opposite sides of one end of the spanning member 1 such that that they extend past its end. A jig can be used to properly align the holes 6 and 12 of the side plates such that a line through the center of a hole 12 in one side plate 5, and passing through the center of its respective hole 12 in the other side plate 5, is perpendicular to the spanning member 1. The side plates 5 can then be welded into position.

Another set of small side plates 9, with two holes 10 each, can be constructed and attached to the other end of the spanning member 1 in a similar fashion. In the space between these two plates 9, there can be a spacer 16 on each side of the spanning member 1 for bolting the frame to a floor. Such a spacer 16 can be constructed by shearing sections of stock steel and punching a hole 17 near the center. The spacers 16 can then be welded between the two plates 9 thus forming a brace that can bolt to a hard surface to hold the spanning member 1 vertical. Small strips of thin steel can be welded inside the spanning member 1 near the brace thus creating a flange 19 as shown in FIG. 22.

A stake 13 can be partly constructed out of a steel tube with small strips of steel welded all the way around one end to form a flange 18 as shown in FIG. 22. Sections of solid round rod can be cut at angles and inserted part way into the other end of the stake 13 and welded to create a sharpened point. A pin hole can be drilled in the stake 13 before inserting it into the spanning member 1 via the housing assembly end.

A first arm component 2 can be constructed out of steel square tubing with holes drilled at each end. An end of the first arm component 2 attaching to a housing assembly 1 can be slightly bent allowing it to curve further over the top of the spanning member 1 as shown in FIG. 21. A second arm component 3 can be constructed by taking two adjacent sections of steel square tubing and offsetting them a distance of at least the thickness of the first arm component 2. A steel offset can be welded between the two sections at the top and bottom of the second arm component 3 thus preserving this shape. The relationship between the arm components should be such that the second arm components 3 are slightly less wide than the spanning member 1, and a first arm component 2 fits between the two square tubes of the second arm component 3 with enough room for a washer on each side. A jig can be used to drill three holes in each second arm component 3 in the proper positions: each hole must go through both square tubes of each second arm component 3: one hole is drilled at each end, and a third hole is drilled at the pivot point between the first arm component 2 and the second arm component 3 creating hole 4.

Each second arm component 3 can then be positioned such that one end is positioned between the two plates 5 of a housing assembly, and the other end is positioned between the two plates 9 of a brace. A pin can then be inserted through the outer most holes 6 of a housing assembly and a second arm component 3, along with a pin through a brace and the same second arm component 3, thus securing the second arm component 3 to a spanning member 1 at both ends. Likewise, the other second arm component 3 can then be secured to the spanning member 1 as well.

A first arm component 2 can now be attached to a second arm component 3 via a pin through the hole at one end of the first arm component 2, and the remaining hole of the second arm component 3. A first arm component 2 should be positioned such that it lies between the two square tubes of a second arm component 3 and is separated from the second arm component 3 on each side by a washer. A steel gear 8 cut with a laser can then be placed on each side of a first arm component 2, centered with the hole. The gears 8, and a first arm component 2 can then be pinned through the inner holes 12, between the two side plates 5 of the housing assembly. Washers may be needed to take up any extra space between the gears 8 and side plates 5. The other first arm component 2 can then be attached in a similar fashion such that the set of gears 8 through one pin are interlocking on the set of gears 8 on the other pin.

Once the arm components are attached and in the closed position, the gears 8 can be welded to their respective first arm components 2 thus forcing one first arm component 2 to rotate relative to the spanning member 1 when the other first arm component 2 does. The pins securing the first arm component 2 to the housing assembly, along with the pins connecting the first arm component 2 and the second arm component 3 can now be welded in place to prevent them from falling out. Everything can then be cleaned for painting.

A sign face 14 can be constructed of a banner material with printing on one side. For additional strength, Power Tape can be applied to the back side of a face 14. Four grommets 15; one at each corner can be used to hold the face(s) 14 to an open frame. The same four pins used to hold the arms in a closed position can be used to hold the face(s) 14 to the frame by inserting a pin through a grommet 15 in one face 14, then back into the hole in the second arm component 3, and then through a grommet 15 in the other face 14.

### Means of Erecting:

A Ninja Sign can be mounted to a solid surface by placing a bolt through the top end of each hole 17 and threading it through a solid surface to secure the Ninja Sign in a vertical position.

A Ninja Sign can be mounted in the ground by extending stake 13 out the brace end of spanning member 1. A pin through stake 13 is then inserted to prevent stake 13 from sliding all the way back inside spanning member 1, as shown in FIG. 3. With the arms in a closed position, a Ninja Sign can be lifted vertical into hammering position A as shown in FIG. 4. By holding the arms of a Ninja Sign, one in each hand, a Ninja Sign frame can then be elevated into hammering position B as shown in FIG. 5. A Ninja Sign frame can then be used as a post driver by slamming it down vertically onto a pin through stake 13; thus, inserting stake 13 partially into the ground as shown in FIG. 6. Repeating this concept by moving a Ninja Sign frame into a position shown in FIG. 7 and slamming it into a position shown in FIG. 8 inserts a stake 13 further into the ground. This process can be repeated until stake 13 is inserted sufficiently into the ground. In cases where stake 13 doesn't need to be inserted into the ground to where its pin is at ground level, the pin can be removed allowing the frame to rest on the ground.

After securing a Ninja Sign frame in a vertical position (See FIG. 11), the second arm components 3 can be disconnected from the housing assembly and brace. This can be done by removing the pins through holes 6 and 7, and the pins through holes 10 and 11 respectively. The first arm components 2 can then be rotated until horizontal as shown in FIG. 13. A pin can then be reinserted into one hole 6 such that a first arm component 2 can rest on this pin thus holding the first arm components 2 horizontal. Second arm components 3 can then be rotated into position for attaching a face, as shown in FIG. 15.

A face 14 can be attached to the arms of a Ninja Sign by inserting a pin through a grommet 15 in the face 14, and then inserting it into hole 7 in a second arm component 3. Repeat this with hole 7 of the other second arm components 3, and hole 11 of one second arm component 3 as shown in FIG. 16. From the position shown in FIG. 16, apply a force from the unattached end of the second arm component 3 that is directed towards the housing assembly; this will cause the arms to elevate, bringing the remaining corner of the face 14, and the remaining hole 11 of a arm, in closer proximity of each other. Remove the pin from hole 6 in the housing assembly (the one that was holding the first arm components 2 horizontal), and insert it through the remaining grommet 15 in the face 14, and the remaining hole 11.

Thus we have one face 14 attached to a Ninja Sign frame. If a second face 14 is desirable, start at the position shown in FIG. 16. Attach a second face 14 by inserting the second face 14 onto the end of the pins that are holding the first face 14 (each pin will be inserted through the first face 14, then through the second arm component 3, and then through the second face 14). Then proceed as instructed above and connect the remaining corner of the second face 14 onto the final pin.

### Means of Removing:

While holding one of the second arm components 3 near hole 11, apply a small force towards the housing assembly; such force should be just enough to remove pressure on adjacent corner of face 14. Remove adjacent pin, thus freeing that corner of the face(s) 14. Proceed to allow the second arm components 3 to slowly lower by reducing the amount of force applied towards the housing assembly. Once the arms are down, proceed to remove the pins that are securing the face(s) 14 to the arms. Roll the face(s) 14 around a small shipping tube to preserve shape and prevent unnecessary wrinkles. Pin the arms in closed position by reinserting the pins through holes 6 and 7, and 10 and 11 respectively.

If the Ninja Sign was mounted to a solid surface, simply remove the bolts through the brace to remove the sign. If the Ninja Sign was mounted using stake 13, use the frame as a reverse post driver to remove stake 13. This can be done by ramming the frame up until it is stopped by flange 18 of stake 13 hitting flange 19 in the spanning member 1 (see FIG. 22). Thus, starting from the position shown in FIG. 10, proceed to ram the frame upwards into the position shown in FIG. 9. Slowly lower the frame into the position shown in FIG. 8, and proceed to ram the frame up into the position shown in FIG. 7. Repeat this process until stake 13 is removed from the ground. Lay the Ninja Sign on the ground, remove the pin from stake 13, and then slide stake 13 back inside spanning member 1.

### Distinguishing Between Prior Art:

There are a wide variety of sign designs considered prior art; none of them having means of inserting a stake into, and removing a stake from, the ground. Additionally, none of them collapse into a compact position that is convenient to fit in a vehicle without having a disconnected arm component that can get lost. It is desirable to provide a commercial or residential size sign that collapses to fit in a vehicle, doesn't require any tools, holds against significant wind speeds, and is simple to use, in the form of a Ninja Sign.

What is claimed is:

1. A Ninja Sign comprising:
A spanning member coupling a mounting device to a housing assembly; the mounting device having means of coupling the spanning member, in a relatively vertical position, to a surface or a stake; the housing assembly pivotally coupled to at least one first arm component such that the first arm component rotates from a closed to an open position about a joint; a first arm component being adjacent to a spanning member in a closed position; and an arm comprising a means of coupling to a face.

2. The Ninja Sign of claim 1 comprising a first arm component held in an open position by restricting the motion of a joint.

3. The Ninja Sign of claim 1 comprising a first and second arm.

4. The Ninja Sign of claim 3 comprising a 1^{st} first arm component having a limited rotation in a direction, and a 2^{nd} first arm component having a limited rotation in an opposite direction.

5. The Ninja Sign of claim 4 comprising: a 1^{st} first arm component that rotates past horizontal, on a vertically positioned spanning member into an open position, a 2^{nd} first arm component that rotates in an opposite direction, and each arm comprising means of coupling to a face.

6. The Ninja Sign of claim 2 comprising a spanning member that is, or couples to, a post driver for hammering a stake into, or reverse hammering a stake out of, the ground.

7. The Ninja Sign of claim 3 comprising: a spanning member that is, or couples to, a post driver for hammering a stake into, or reverse hammering a stake out of, the ground.

8. The Ninja Sign of claim 3 wherein at least two first arm components pivot at a relatively common elevation on a housing assembly when a spanning member is in a vertical position.

9. The Ninja Sign of claim 8 comprising: a 1^{st} second arm component pivotally coupled to a 1^{st} first arm component; a 2^{nd} second arm component pivotally coupled to a 2^{nd} first arm component; and a means of coupling the arms to a common face.

10. The Ninja Sign of claim 9 wherein a spanning member is, or couples to, a post driver for inserting a stake into, or removing a stake from, the ground.

11. The Ninja Sign of claim 1 comprising: 4 first arm components that couples to a face in an open position; a spanning member comprising means of being used as, or coupling to, a post driver for inserting a stake into, or removing a stake from, the ground.

12. The Ninja Sign of claim 10 comprising a spanning member that is, or couples to, a post driver for inserting a stake into, or removing a stake from, the ground; the stake being shaped to reduce rotation.

13. A Ninja Sign comprising:
A spanning member coupling a mounting device to a housing assembly: the mounting device comprising means of coupling the spanning member, in a relatively vertical position, to a surface or a stake; a housing assembly pivotally coupling two first arm components such that each pivot is at a relatively common elevation when the spanning member is in a vertical position; a 1^{st} second arm component pivotally coupled to a 1^{st} first arm component, and a 2^{nd} second arm component pivotally coupled to a 2^{nd} first arm component; and each second arm component comprising means of attaching to a common face.

14. The Ninja Sign of claim 13 comprising arms that hold a face relatively symmetrical about a line through a housing assembly.

15. The Ninja Sign of claim 14 comprising first arm components that are pivotally coupled about a point near the middle of a respective second arm component, such that each second arm component comprises means of coupling to a face above and below the respective pivot.

16. The Ninja Sign of claim 15 comprising first arm components that rotate past horizontal, on a vertical spanning member, into an open position.

17. The Ninja Sign of claim 16 comprising a mechanical system coupling both arms such that when one first arm component rotates in one direction relative to a spanning member, another first arm component rotates in the opposite direction.

18. The Ninja Sign of claim 17 comprising means of being used as, or attaching to, a post driver for inserting a stake into, or removing a stake from, the ground.

19. The Ninja Sign of claim 18 comprising a spanning member that accommodates a stake for storage such that the stake can be extended past the mounting device end and secured for using the spanning member as a post driver or a reverse post driver.

20. The Ninja Sign of claim 18 comprising two arms that rotate into closed position such that the two second arm components lie adjacent to a spanning member.

21. The Ninja Sign of claim 20 comprising a means of limiting arm motion in a closed position.

22. The Ninja Sign of claim 20 comprising second arm components that lie in a region on or between a housing assembly and a mounting device respectively in a closed position.

23. The Ninja Sign of claim 17 wherein a mechanical system comprises a set of similar interlocking gears wherein a gear is coupled to a 1^{st} first arm component and centered about a pivot thereof, and a second gear being coupled to a 2^{nd} first arm component and centered about a pivot thereof.

24. The Ninja Sign of claim 17 comprising a mechanical system that allows the surface area of a face to be reduced by the wind.

25. The Ninja Sign of claim 14 comprising third arm components coupled to second arm components respectively such that the third arm components help form a face frame.

26. The Ninja Sign of claim 25 comprising means of being used as, or coupling to, a post driver for inserting a stake into, or removing a stake from, the ground.

27. The Ninja Sign of claim 13 comprising a foldable, or role able, face.

28. A ninja Sign comprising:
A sign frame that is, or couples to, a post driver for inserting a stake into, or removing a stake from, the ground.
